(19) United States
(12) Patent Application Publication
(10) Pub. No.: US 2011/0037228 A1
(43) Pub. Date: Feb. 17, 2011

(54) BLADE SEAL WITH IMPROVED BLADE SEAL PROFILE

(76) Inventors: Philip M. Thomas, JR., Greenville, SC (US); Wesley R. Burcham, Boiling Springs, SC (US)

Correspondence Address: DON W. BULSON (PARK);RENNER, OTTO, BOISSELLE & SKLAR, LLP, 1621 EUCLID AVENUE / 19TH FLOOR, CLEVELAND, OH, 44115, US

(21) Appl. No.: 12/845,172

(22) Filed: Jul. 28, 2010

Related U.S. Application Data
(60) Provisional application No. 61/233,888, filed on Aug. 14, 2009.

(51) Int. Cl. F16J 15/06; F16J 15/02; F16J 15/10

(52) U.S. Cl. 277/312; 277/628

(57) ABSTRACT

The present invention provides a blade seal for use with a blade that compresses the blade seal to form a seal across a sealing junction. The blade seal includes a recessed ridge for receiving the blade and having a plurality of ridge contact points. When the blade compresses the blade seal to form the seal, the plurality of ridge contact points contacts the blade. The blade seal also may include side lobes extending from the recessed ridge and having respective lobe contact points. When the blade compresses the blade seal, the lobe contact points also contact the blade. The blade seal also includes a secondary sealing portion. When the blade compresses the blade seal to form the seal, the recessed ridge presses against the secondary sealing portion. The multiple contact points between the blade seal and blade, and the presence of a secondary sealing portion, enhance the efficacy of the seal.

### RELATED APPLICATION

This application claims the benefit of U.S. Provisional Patent Application Ser. No. 61/233,888 filed Aug. 14, 2009, which is hereby incorporated herein by reference.

### FIELD OF THE INVENTION

The present invention is directed to a blade seal member for use with a blade seal assembly, and particularly a blade seal having a blade seal profile for self-aligning the seal with the blade at multiple points of contacts.

### BACKGROUND OF THE INVENTION

Blade seals are used in the art for sealing cabin openings, such as doorways. Blade seals have particular use in applications in which a pressure differential may exist as between inside the cabin and the exterior. For example, a pressurized airplane cabin, particularly at relatively high cruising altitudes, has a relatively high interior pressure as compared to the pressure outside the airplane. Blade seals may be used to seal the airplane door to aid in maintaining the interior pressure of the cabin during flight.

FIGS. 1A-1B depict a conventional blade seal 10. In particular, FIG. 1A is a schematic perspective view of a length of the blade seal 10. The blade seal 10 includes a sealing portion 12 and feet 14. The blade seal 10 may have a cross-sectional blade seal profile 16, including in cross-section the sealing portion 12 and feet 14. The blade seal 10 may include a plurality of holes drilled through the sealing portion 12, one example of which is shown as element 18 in FIG. 1B. It will be appreciated that more than one such hole may be present. The hole represented by element 18 is shown by the hatched lines as being internal within the blade seal, and typically would be formed on the inside or cabin-side portion of the blade seal. During operation in a pressurized environment, such as an airplane door, a pressure differential may cause air to fill a hollow portion or space 20 of the blade seal to increase the sealing pressure of the seal. The blade seal 10, therefore, is sometimes referred to in the art as a “passive inflatable seal.” The seal is “passive” because the seal is inflated due to the cabin pressure without utilizing an active pump or comparable air source.

Also as shown in FIGS. 1A and 1B, the profile of the sealing portion 12 is substantially elliptical in shape enclosing the inner hollow space 20. The feet 14 may be formed of extensions contiguous with the sealing portion. The feet provide structure for securing the blade seal within a location to be sealed, such as the frame of a doorway or comparable sealing junction.

FIGS. 2A and 2B show the operation of the conventional blade seal 10 in a blade seal assembly including the blade seal and a blade. The blade seal 10 may be positioned within a receiving portion 22 of a support structure 24. For example, the support structure 24 may be an airplane door frame. In the example of FIG. 2A, the support structure 24 has a pair of receiving members 26 with protrusions 28 that form a slot 29 in which the feet 14 may be securely received. The sealing portion 12 may extend outward relative to the slot.

The blade seal 10 is positioned so the sealing portion 12 receives a blade 30. The blade 30 may include a blade post 31 attached to a blade base 32. For example, the blade base 32 may be provided around the edge of an airplane door for closing against an airplane door frame in the form of seal support structure 24. In the example of an airplane, the blade seal 10 is provided along the perimeter of the door frame with the top of the seal portion facing outward relative to the interior of the airplane cabin. The blade 30 is provided along the perimeter of the door so that the blade post 31 points toward the interior of the plane cabin, i.e., faces oppositely to the sealing portion so the blade post 31 and sealing portion 12 come in contact as the door is closed. FIG. 2A shows the blade seal assembly configuration as the blade post 31 first makes contact with the sealing portion 12.

As shown in FIG. 2B, when the door is closed the blade post 31 of the blade 30 compresses the sealing portion 12, thereby distorting the elliptical shape of the sealing portion. The sealing portion 12 and blade 30 thus form a seal across a sealing junction 34 between support structure 24 (e.g., the door frame) and the blade base 32 (e.g., the door edge).

The conventional blade seal configuration has certain deficiencies. The sealing portion typically has only one point of contact with the blade. A tear in the sealing portion, therefore, may result in a disengagement of the sealing portion from the blade. Pressurized air, therefore, may rush out of the cabin via the torn seal portion. The integrity of the seal may become comprised. Even when seal tears remain relatively inconsequential from a safety standpoint, the airflow tends to result in heat loss from the cabin and increased noise that both may be irritating or uncomfortable to passengers.

As also is known in the art, there is a potential for a degree of misalignment to occur between the blade seal and the blade. Another disadvantage of the conventional blade seal is that even a relatively small misalignment of the blade and blade seal results in an asymmetrical compression of the blade seal, which can result in a less solid seal.

Another disadvantage of conventional blade seals is that to minimize the potential effect of a blade seal tear, the blade seal may be divided into numerous segments joined together at splice joints. At the splice joints, foam plugs in the form of silicone tubing or the like may be provided to separate adjacent components of the blade seal. The foam plugs act as air dams to prevent air flow from a torn segment to adjacent segments, thereby limiting the effects of a tear essentially to one seal segment.

FIG. 3 depicts a typical airplane fuselage section 35 having a door 36 and door frame 38. The blade seal 10 is provided along the inside of the doorway. The circles in FIG. 3 show exemplary approximate locations 40 of the splice joints in an airplane door frame having a conventional blade seal. The force of the pressure differential tends to maximize about the corner areas of the door. As many as twenty splice joints may be present in a typical door frame to limit the effects of a tear in any given segment, with the majority of the splice joints being provided in the area of the corners of the door frame. The numerous splice joints, and corresponding foam plugs or silicone tubing provided in conjunction with conventional airplane door blade seals, increase the costs and complexity of manufacture. In addition, the splice joints themselves provide potential points of weakness of the seal, and therefore it would be desirable to reduce the number of splice joints to as few as practicable.

### SUMMARY OF THE INVENTION

The present invention provides an improved blade seal that does not require the use of significant additional silicone tubing, and can maintain seal integrity with as little as four splice joints (one at each corner). The blade seal of the present invention has a blade seal profile that self-aligns the blade seal with the blade at multiple points of contacts. The blade seal has a primary sealing portion, and a secondary sealing portion that maintains the integrity of the seal in the event of a tear in the primary sealing portion. As a result, the blade seal of the present invention reduces noise and provides enhanced thermal integrity as compared to the conventional configuration.

An aspect of the present invention, therefore, includes a blade seal for use with a blade that compresses the blade seal to a compressed state to form a seal across a sealing junction. Embodiments of the blade seal may include a recessed ridge for receiving the blade and having a plurality of ridge contact points. When the blade seal is in the compressed state to form the seal, the plurality of ridge contact points contacts the blade. The blade seal also may include side lobes extending from the recessed ridge and having respective lobe contact points. When the blade seal is in the compressed state, the lobe contact points also contact the blade. The blade seal also may include a secondary sealing portion. When the blade seal is in the compressed state to form the seal, the recessed ridge presses against the secondary sealing portion. The multiple contact points between the blade seal and blade, and the presence of the secondary sealing portion, enhance the efficacy of the seal.

Another aspect of the invention is a blade seal assembly for forming a seal across a sealing junction. Embodiments of the blade seal assembly may include a blade seal as described above, and a blade that compresses the blade seal to a compressed state to form the seal. When the blade seal is in the compressed state, the blade seal has multiple contact points that contact the blade. The blade seal of the blade seal assembly also may include a secondary sealing portion. When the blade seal is in the compressed state to form the seal, a recessed ridge of the blade seal presses against the secondary sealing portion.

Another aspect of the invention is a method of sealing a sealing junction. Embodiments of the method may include providing a blade seal, wherein the blade seal has a recessed ridge and a plurality of ridge contact points. The method may further include providing a blade, and compressing the blade seal by pressing the blade against the recessed ridge. When the blade compresses the blade seal to form the seal, the blade seal contacts the blade at a plurality of contact points. The blade seal may include a secondary sealing portion, and when the blade compresses the blade seal to form the seal, the recessed ridge presses against the secondary sealing portion.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF DRAWINGS

FIGS. 1A-1B are schematic diagrams depicting a conventional blade seal.

FIGS. 2A and 2B are schematic diagrams depicting a conventional blade seal assembly having a conventional blade seal in conjunction with a blade.

FIG. 3 is a schematic diagram of an exemplary airplane door showing the location of splice joints in a conventional blade seal configuration.

FIGS. 4A and 4B are schematic diagrams depicting an exemplary blade seal in accordance with embodiments of the present invention.

FIG. 5 depicts an exemplary blade seal assembly having a blade seal and blade in accordance with embodiments of the present invention, with the blade seal in an uncompressed state.

FIG. 6 depicts an exemplary blade seal assembly having a blade seal and blade in accordance with embodiments of the present invention, with the blade seal in a compressed state.

FIG. 7 is a schematic diagram of an exemplary airplane door showing the location of splice joints in a blade seal configuration in accordance with embodiments of the present invention.

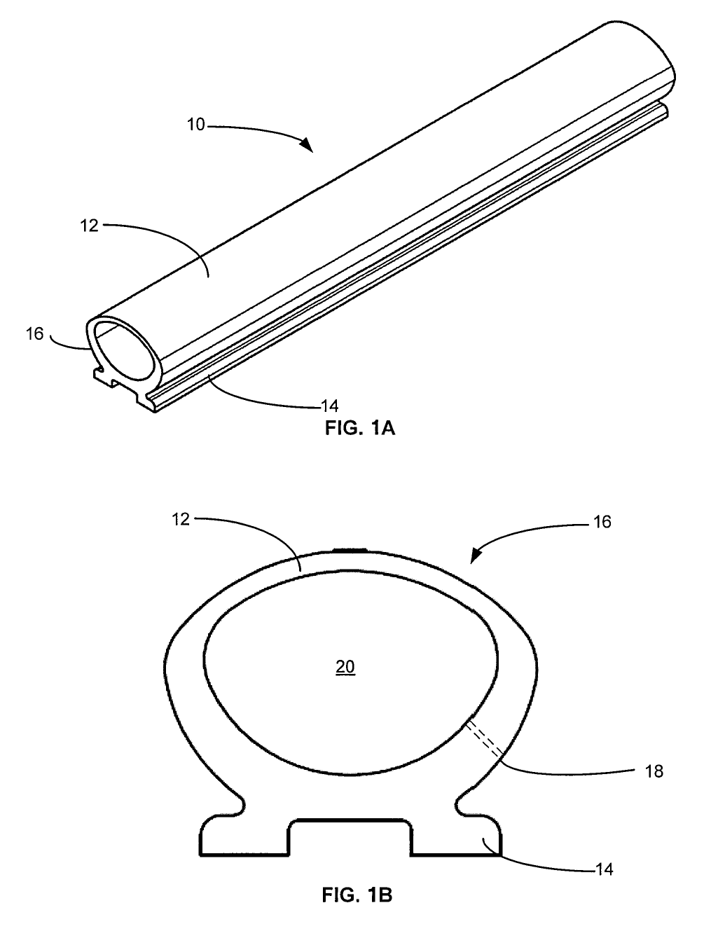

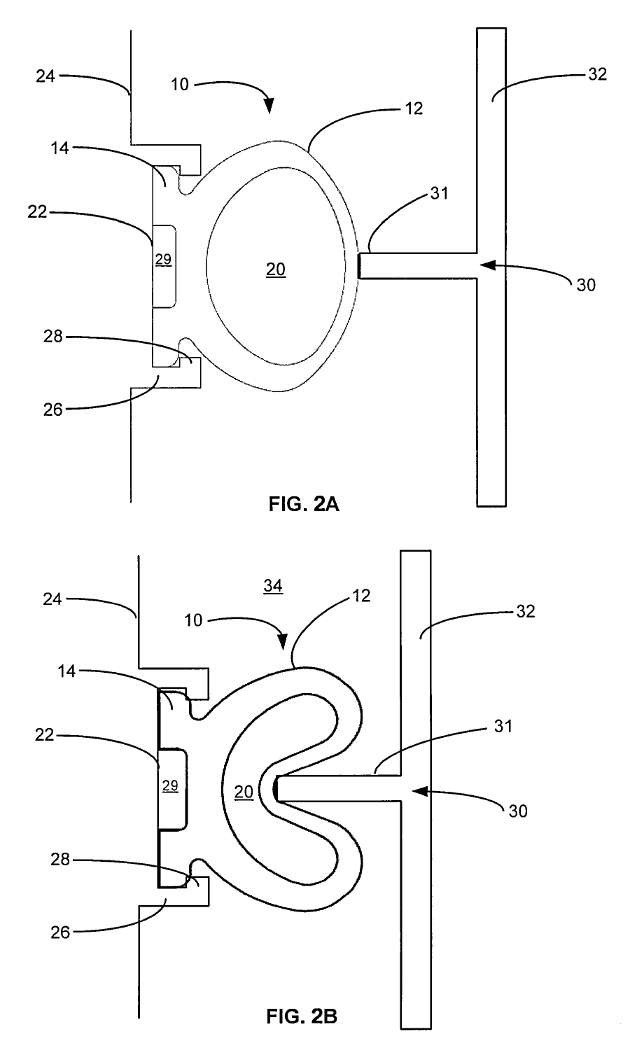

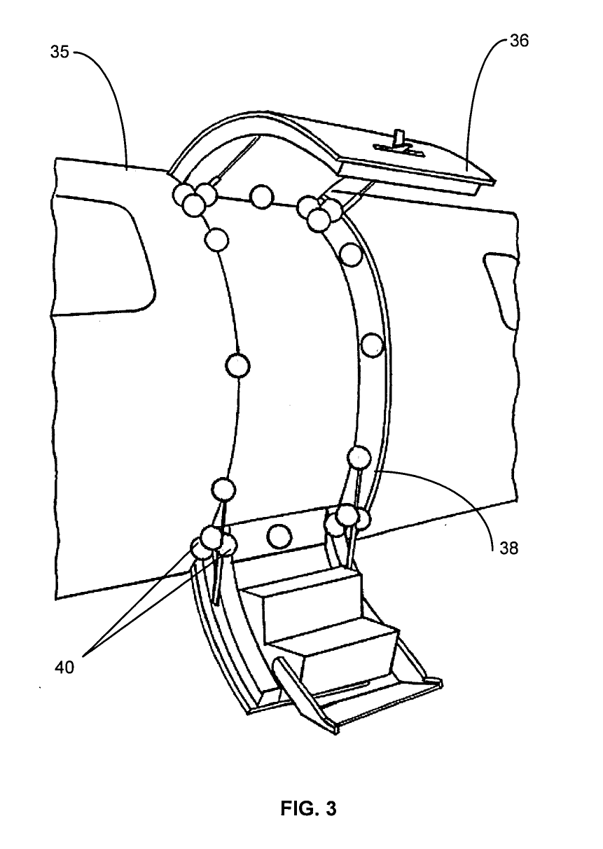

### DETAILED DESCRIPTION

Embodiments of the present invention will now be described with reference to the drawings, wherein like reference numerals are used to refer to like elements throughout. It will be understood that the figures are not necessarily to scale.

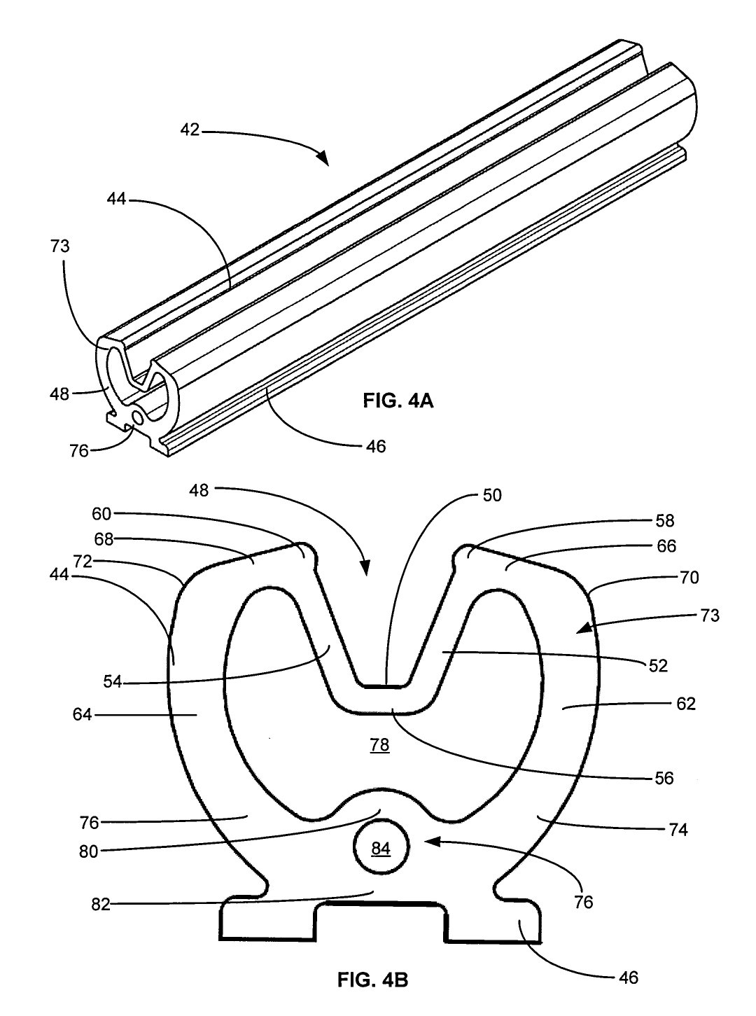

The present invention provides a blade seal for use with a blade that compresses the blade seal to a compressed state to form a seal across a sealing junction. FIGS. 4A and 4B are schematic diagrams depicting an exemplary blade seal 42 in accordance with embodiments of the present invention. Blade seal 42 includes a sealing portion 44 and an anchor portion 46. The anchor portion 46 may be in the form of feet comparable to the conventional blade seal. The sealing portion 44 has a cross-sectional blade profile 48 that may be symmetric about a center vertical line.

The blade seal profile 48 may include a recessed ridge 50 for receiving a blade. The recessed ridge may have a plurality of ridge contact points for contacting the blade as further explained below. The recessed ridge 50 may have a flattened “V-shape” with a first side leg 52, a second side leg 54, and a base 56 extending between ends of the side legs. The side legs may extend from opposite ends of the base to a respective first contact protrusion 58 and a second contact protrusion 60 that provide two respective points of contact with the blade.

The blade seal profile 48 of blade seal 42 further may include a first side lobe 62 and a second side lobe 64 that extend between the anchor portion or feet 46 and respective side legs 52, 54 of the recessed ridge 50. The side lobes 62 and 64 may include respective first upper lobe portion 66 and second upper lobe portion 68. The upper lobe portions may extend between the respective first and second contact protrusions 58 and 60, and respective first lobe contact point 70 and second lobe contact point 72. The side lobes 62 and 64 further may include respective first descending side 74 and second descending side 76 between the respective lobe first and second contact points 70, 72 and the anchor portion 46.

The recessed ridge 50 and side lobes 62 and 64 form a primary sealing portion 73. The blade seal 42 also may include a secondary sealing portion 76. The primary sealing portion 73 and secondary sealing portion 76 define a first inner space 78. The secondary sealing portion 76 may be positioned in a region of the profile in which the anchor portion 46 and two side lobes come together. The secondary sealing portion may include an upper arc 80 and a base 82 that define a second inner space 84.

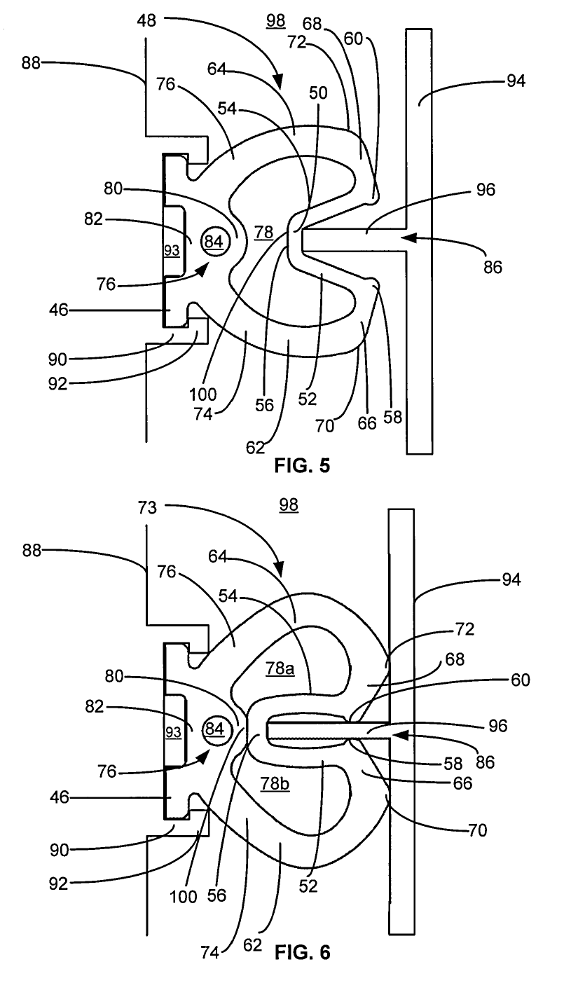

FIG. 5 depicts an exemplary blade assembly for forming a seal across a sealing junction 98. The blade seal assembly has the blade seal 42 of FIGS. 4A and 4B, and a blade 86. The blade seal 42 is shown in cross-section facing the blade profile seal 48. In the blade seal assembly, the blade may press against the blade seal to compress the blade seal from an uncompressed state to a compressed state. In FIG. 4A, the blade seal is in the uncompressed state just coming into contact with the blade 86. Portions of the blade seal profile 48 are labeled in FIG. 5 as in FIGS. 4A and 4B. The blade seal may be positioned in a housing 88 similar to that of a conventional blade seal. For example, the housing 88 may have a pair of receiving members 90 with protrusions 92 that form a slot 93 in which the feet 46 may be securely received. The primary sealing portion of the blade seal may extend outward relative to the slot. The blade 86 may have a blade base 94, and a blade post 96 that extends perpendicularly from the blade base 94. As depicted in FIG. 5, the blade post 96 may have a rectangular cross section.

In exemplary embodiments, the housing 88 may be formed in a door frame of an airplane. In this manner, the blade seal 42 may extend along the zo perimeter of the door frame. The blade seal may be provided along the perimeter of an airplane such that when the door is closed, the blade seal and blade cooperate to form a seal in a sealing space between the door frame and the door. In an exemplary configuration, the blade seal is positioned with the recessed ridge 50 facing outward relative to the interior of the airplane. The blade faces oppositely, toward the interior of the airplane when the airplane door is in the closed position.

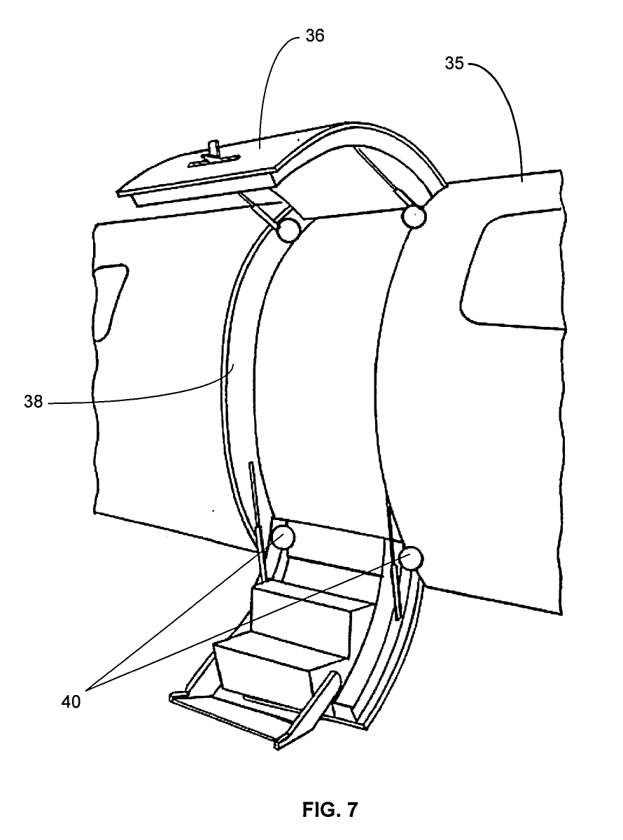

FIG. 6 depicts the exemplary blade seal assembly of FIG. 5 with the blade seal in a compressed state to form the seal across the sealing junction 98. FIG. 6 represents the configuration of the blade seal and blade when a door, for example, is in the closed position. When the blade seal is in the compressed state, the blade post 96 presses against the recessed ridge 50 of the sealing portion of the blade seal. As the compression occurs, the recessed ridge collapses inward toward the blade post 96, which pulls the lobes 62 and 64 inward toward the blade post as well.

The result is multiple contacts between the blade seal and the blade when the blade seal is in the compressed state. For example, as shown in FIG. 6, there are five points of contact between the blade seal and the blade as follows. In the compressed state, the recessed ridge 50 has a plurality of ridge contact points for contacting the blade. The first ridge contact point is the base 56 of the recessed ridge 50, which contacts an end of the blade post 96. A second ridge contact point is the first protrusion 58, which contacts the blade post spaced apart from the base 56. A third ridge contact point is the second protrusion 60, which contacts and the blade post 96 oppositely to the first protrusion. In addition, the first side lobe contact point 70 and second side lobe contact point 72 contact the blade at the blade base 94 on opposite sides of the blade post 96. In this manner, in the compressed state the blade seal 42 contacts the blade 86 at five points. It will be appreciated that configurations having a number of multiple contact points other than five may be provided, and the above configuration is an exemplary embodiment.

In addition, the base 56 of the recessed ridge 50 has a first side facing and for receiving the blade, and a second side 100 facing oppositely toward the second sealing portion 76. When the blade seal is in the compressed state to form the seal, the second side 100 presses against the upper arc 80 of the secondary sealing portion 76. In this manner, the inner space 78 is divided into separate inner spaces 78a and 78b.

The blade seal may be made of any suitable flexible material that permits the blade seal to attain the described compressed state when pressed by the blade. Exemplary materials may include flexible silicones, synthetic rubber materials, fiber-reinforced flexible polymers, and similar materials. The blade seal may be extruded as a tubular member (see, e.g., FIG. 4A) having the profile 48 described above. In one embodiment, the sealing portion 44 of the blade seal may include a configuration of holes to provide an inflatable seal. Note, however, the blade profile of the present invention maintains seal integrity even when the seal material is not configured to be inflatable. The blade may be made of any suitable rigid material capable of compressing the blade seal. Exemplary materials include metals, particularly non-corrosive metals such as stainless steel, or suitable rigid plastic materials as are known in the art.

The present invention also provides a method of sealing a sealing junction with a blade seal assembly. The method may include providing a blade seal, wherein the blade seal has a recessed ridge and a plurality of ridge contact points. The method may further include providing a blade, and compressing the blade seal by pressing the blade against the recessed ridge. When the blade compresses the blade seal to form the seal, the plurality of ridge contact points contacts the blade. The blade seal may include a plurality of side lobes having a plurality of respective lobe contact points. When the blade compresses the blade seal, the plurality of lobe contact points contacts the blade. The blade seal also may include a secondary sealing portion. When the blade compresses the blade seal to form the seal, the recessed ridge presses against the secondary sealing portion.

The blade seal profile of the present invention has advantages over the conventional configuration of the elliptical sealing portion. When compressed, the blade seal profile of the present invention provides multiple points of contact, (as many as five points of contact) with the blade, rather than one point of contact as in the conventional configuration. The multiple contact points provide for enhanced seal efficacy as compared to the conventional configuration. Relatedly, when the recessed ridge 50 is pressed against the secondary sealing portion 76, an additional sealing layer is provided. As a result, the integrity of the seal may be maintained even if a tear should occur elsewhere in the blade seal, such as a tear in one of the side lobes. The blade seal profile of the present invention, therefore, is less susceptible to thermal loss and noise caused by airflow across a torn seal.

Relatedly, in contrast to the conventional configuration, in the present invention a misalignment that may occur between the blade seal and blade does not result in any appreciable reduction of seal integrity. Even a somewhat asymmetrical compression still results in multiple contact points of the blade seal and blade, and the secondary seal still provides for enhanced sealing. As a result, misalignment of the blade seal and blade does not reduce seal integrity as in the conventional configuration.

In addition, the blade seal profile of the present invention maintains the integrity of the seal with a substantially reduced number of splice joints as compared to the conventional blade seal. FIG. 7 is a schematic diagram of an exemplary airplane door similar to FIG. 3 showing the approximate exemplary locations 40 of splice joints in a blade seal configuration in accordance with embodiments of the present invention. As seen in the example of FIG. 7, the integrity of the seal may be maintained using as little as four splice joints (e.g., one at each door frame corner where the force generated by the pressure differential is greatest). Comparing FIG. 7 to FIG. 3, the number of splice joints is substantially reduced by the present invention as compared to the conventional blade seal. The present invention, therefore, maintains an enhanced proper seal with reduced components and complexity as compared conventional blade seals. By employing fewer splice joints, the blade seal of the present invention also has fewer points of potential weakness as compared to the conventional configuration.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A blade seal for use with a blade that compresses the blade seal to a compressed state to form a seal across a sealing junction, the blade seal comprising:
a recessed ridge for receiving the blade and having a plurality of ridge contact points;
wherein when the blade seal is in the compressed state to form the seal, the plurality of ridge contact points contacts the blade.

2. The blade seal according to claim 1, wherein the recessed ridge comprises a base for receiving the blade, and a first ridge contact point is the base.

3. The blade seal according to claim 2, wherein the recessed ridge further comprises a first side leg extending from an end of the base to a first contact protrusion, and a second ridge contact point is the first contact protrusion.

4. The blade seal according to claim 3, wherein the recessed ridge further comprises a second side leg extending from an end of the base opposite the first side leg to a second contact protrusion, and a third ridge contact point is the second contact protrusion.

5. The blade seal according to claim 4, further comprising:
a first side lobe extending from the first side leg of the recessed ridge and having a first lobe contact point;
wherein when the blade seal is in the compressed state, the first lobe contact point contacts the blade.

6. The blade seal according to claim 5, wherein the first side lobe has a first upper lobe portion extending from the first contact protrusion to the first lobe contact point.

7. The blade seal according to claim 6, further comprising:
an anchor portion for anchoring the blade seal to a support; and
the first side lobe has a first descending side extending from the first lobe contact point to the anchor portion.

8. The blade seal according to claim 7, further comprising:
a second side lobe extending from the second side leg of the recessed ridge and having a second lobe contact point;
wherein when the blade seal is in the compressed state, the second lobe contact point contacts the blade.

9. The blade seal according to claim 8, wherein the second side lobe has a second upper lobe portion extending from the second contact protrusion to the second lobe contact point.

10. The blade seal according to claim 9, wherein the second side lobe has a second descending side extending from the first lobe contact point to the anchor portion.

11. The blade seal according to claim 1, further comprising a secondary sealing portion, wherein when the blade seal is in the compressed state to form the seal, the recessed ridge presses against the secondary sealing portion.

12. The blade seal according to claim 11, wherein the recessed ridge comprises a base having a first side for receiving the blade and a second side opposite the first side; and
when the blade seal is in the compressed state to form the seal, the second side of the recessed ridge presses against the secondary sealing portion.

13. The blade seal according to claim 12, wherein the secondary sealing portion comprises and upper arc and a base defining an inner space therebetween; and
when the blade seal is in the compressed state to form the seal, the second side of the recessed ridge presses against the upper arc of the secondary sealing portion.

14. A blade seal assembly for forming a seal across a sealing junction, the blade seal assembly comprising:
a blade seal according to claim 1; and
a blade that compresses the blade seal to a compressed state to form the seal.

15. The blade seal assembly according to claim 14, wherein the blade comprises a blade post and a blade base; and
when the blade seal is in the compressed state to form the seal, the plurality of ridge contact points contacts the blade post.

16. The blade seal assembly according to claim 15, wherein the blade seal further comprises a plurality of side lobes having a plurality of respective lobe contact points; and
when the blade seal is in the compressed state, the plurality of lobe contact points contacts the blade base.

17. The blade seal assembly according to claim 16, further comprising a secondary sealing portion, wherein when the blade seal is in the compressed state to form the seal, the recessed ridge presses against the secondary sealing portion.

18. A method of sealing a sealing junction comprising the steps of:
providing a blade seal, wherein the blade seal has a recessed ridge and a plurality of ridge contact points;
providing a blade; and
compressing the blade seal by pressing the blade against the recessed ridge, wherein when the blade compresses the blade seal to form the seal, the plurality of ridge contact points contacts the blade.

19. The method of sealing a sealing junction according to claim 18, wherein the blade seal further comprises a plurality of side lobes having a plurality of respective lobe contact points; and
when the blade compresses the blade seal, the plurality of lobe contacts points contact the blade.

20. The method of sealing a sealing junction according to claim 19, wherein the blade seal further comprises a secondary sealing portion, and when the blade compresses the blade seal to form the seal, the recessed ridge presses against the secondary sealing portion.
